(19) United States
(12) Patent Application Publication
(10) Pub. No.: US 2006/0271747 A1
(43) Pub. Date: Nov. 30, 2006

(54) Wireless access device with integrated universal serial bus interface

(75) Inventors: Edward William Geiger, San Martin, CA (US); Kamran Khojasteh, Morgan Hill, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/139,266

(22) Filed: May 26, 2005

(51) Int. Cl. G06F 13/00

(52) U.S. Cl. 711/154; 370/463; 370/338

(57) ABSTRACT

A wireless access device for a wireless local area network (“WLAN”) as disclosed herein includes an integrated universal serial bus (“USB”) interface that enables communication with USB compliant peripheral devices. The peripheral device can be utilized by the wireless access device and/or by other network components that are coupled to the wireless access device via the WLAN. In one practical embodiment, the wireless access device is an access point having a host USB interface, and the USB compliant peripheral device includes a slave USB interface that is compliant with the host USB interface.

### TECHNICAL FIELD OF THE INVENTION

The present invention relates generally to wireless local area networks. More particularly, the present invention relates to a wireless access device, such as an access point or an access port, having an integrated universal serial bus (“USB”) interface.

### BACKGROUND OF THE INVENTION

Wireless local area networks (“WLANs”) can give clients the ability to “roam” or physically move from place to place without being connected by wires. In the context of a WLAN, the term “roaming” describes the act of physically moving between wireless access devices, which may be stand-alone wireless access points or wireless access ports that cooperate with one or more wireless switches located in the WLAN. Many deployments of wireless computer infrastructure, such as WLANs, involve the use of multiple wireless switches serving a number of wireless access devices. Conventional wireless access devices generally function as network interfaces between wireless clients and a traditional computer network, such as a local area network (“LAN”).

Most medium scale, large scale, or enterprise WLAN deployments utilize multiple wireless access devices having wired connections to a network. Generally, wireless access devices are installed in unusual locations, e.g., in ceilings, in walls, or in exterior locations where normally a LAN connection might not be found. Consequently, the installation of a wireless access device may require a LAN connection to be extended to a location where LAN access is not usually available. Historically, such LAN connections are merely utilized to extend the physical reach of the LAN to the installation location of the wireless access points.

Depending upon its intended application, a wireless access device might require a small amount of memory or a significant amount of memory to support its operation. For example, such memory may be desirable to store diagnostic data, to facilitate event logging, to enable performance tracking, and/or to store any other recordable data or information at the wireless access device. A conventional wireless access device, however, typically includes a fixed amount of storage capacity, and expansion of that storage capacity can be an expensive and time consuming modification.

Accordingly, it is desirable to have a wireless access device that can also function to connect peripheral devices to a wired computer network. In addition, it is desirable to have a wireless access device that can be easily modified to expand its memory capacity and/or to expand its functional capabilities. Furthermore, other desirable features and characteristics of the present invention will become apparent from the subsequent detailed description and the appended claims, taken in conjunction with the accompanying drawings and the foregoing technical field and background.

### BRIEF SUMMARY OF THE INVENTION

A wireless access device configured as described herein can be deployed to support a WLAN. The wireless access device includes an integrated USB interface that enables compatible peripheral devices to communicate with the WLAN and/or with other components on the computer network via the wireless access device. Alternatively (or additionally), the wireless access device includes an internal USB interface that facilitates quick and easy factory expansion of memory capacity or other features.

The above and other aspects of the invention may be carried out in one form by a wireless access device for a WLAN. The wireless access device includes an integrated USB interface configured for interconnection with USB compliant peripheral devices. In one practical embodiment, the USB interface is a master/host USB interface.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic representation of a computer network configured in accordance with an example embodiment of the invention;

FIG. 2 is a schematic representation of a wireless access device connected to a peripheral device via USB interfaces; and

FIG. 3 is a schematic representation of a wireless access device configured in accordance with an example embodiment of the invention.

### DETAILED DESCRIPTION OF THE INVENTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to WLANs, data transmission, signaling, network control, wireless access device operation, wireless switch operation, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description may refer to elements or features being “connected” or “coupled” together. As used herein, unless expressly stated otherwise, “connected” means that one element/feature is directly joined to (or directly communicates with) another element/feature, and not necessarily mechanically. Likewise, unless expressly stated otherwise, “coupled” means that one element/feature is directly or indirectly joined to (or directly or indirectly communicates with) another element/feature, and not necessarily mechanically. Thus, although the schematics shown herein depict example arrangements of elements, additional intervening elements, devices, features, or components may be present in an actual embodiment (assuming that the functionality of the network and the devices is not adversely affected).

As used herein, “universal serial bus” and “USB” refers to the standardized serial data communication bus technology of the same name, and these terms contemplate the older USB 1.1 Specification, the newer USB 2.0 Specification, and any future variant or modification thereof. These USB Specifications are incorporated by reference herein. The USB 2.0 Specification and other USB-related technical publications are available at the website www.usb.org.

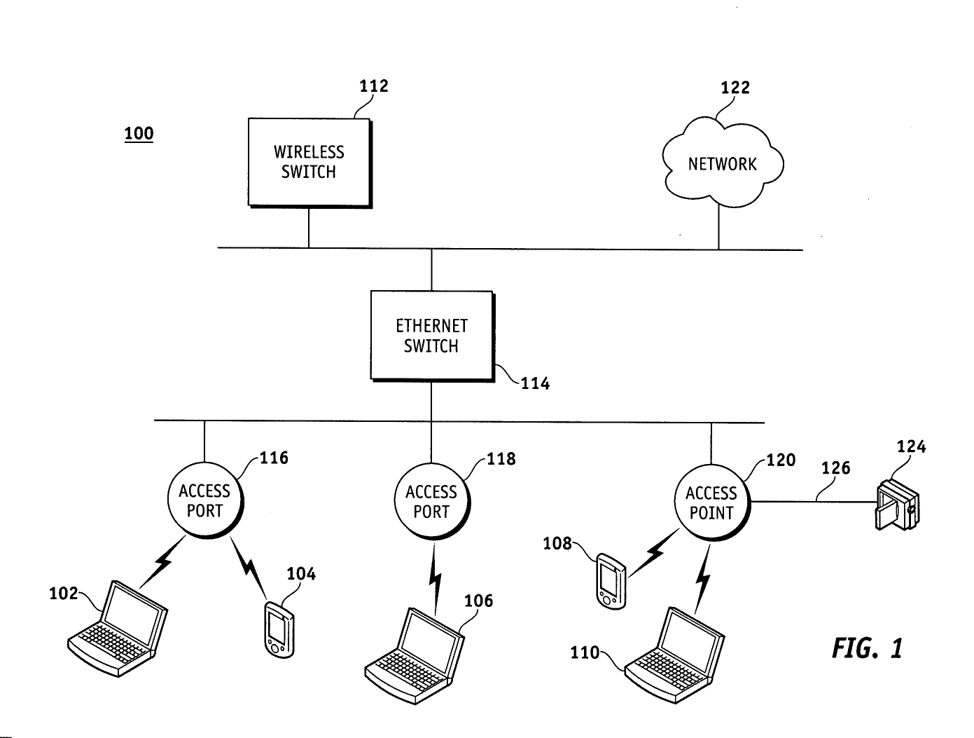

FIG. 1 is a schematic representation of a computer network 100 configured in accordance with an example embodiment of the invention. In this example, computer network 100 includes a WLAN. Computer network 100 generally includes wireless clients (identified by reference numbers 102, 104, 106, 108, and 110), a wireless switch 112 (which need not be utilized in all practical deployments), an Ethernet switch 114, and a number of wireless access devices (identified by reference numbers 116, 118, and 120). Computer network 100 may also include or communicate with any number of additional network components, such as a traditional local area network (“LAN”). In FIG. 1, such additional network components are generally identified by reference number 122. A practical embodiment can have any number of wireless switches (including zero), each supporting any number of wireless access devices, and each wireless access device supporting any number of wireless clients. Indeed, the topology and configuration of computer network 100 can vary to suit the needs of the particular application and FIG. 1 is not intended to limit the application or scope of the invention in any way.

In this example embodiment, wireless access devices 116/118 are realized as wireless access ports, which are “thin” devices that rely on the network intelligence and management functions provided by wireless switch 112, while wireless access device 120 is realized as a wireless access point, which is a “thick” device having the network intelligence and processing power integrated therein. Thus, wireless access point 120 need not rely upon wireless switch 112 for operation. Wireless access ports having conventional features that can be incorporated into wireless access devices 116/118, and wireless access points having conventional features that can be incorporated into wireless access device 120 are available from Symbol Technologies, Inc. Briefly, a wireless access device as described herein is suitably configured to receive data from wireless clients over wireless links. Once that data is captured by the wireless access device, the data can be processed for communication within computer network 100. For example, the data can be encapsulated into a packet format compliant with a suitable data communication protocol. In the example embodiment, data is routed within computer network 100 using conventional Ethernet 802.3 addressing (including standard Ethernet destination and source packet addresses).

Wireless switch 112 is coupled to Ethernet switch 114, which is in turn coupled to wireless access devices 116/118/120. In practice, wireless switch 112 communicates with wireless access devices 116/118 via Ethernet switch 120. A given wireless switch can support any number of wireless access devices, i.e., one or more wireless access devices can be concurrently adopted by a single wireless switch (in the example embodiment, a wireless access device can be adopted by only one wireless switch at a time). The wireless clients are wireless devices that can physically move around computer network 100 and communicate with network components 122 via wireless access devices 116/118/120.

As described herein, a wireless access device (which can be a wireless access point or a wireless access port) is suitably configured to communicate with peripheral devices using one or more standardized data communication bus technologies. For example, wireless access device 120 may be suitably configured to communicate with a peripheral device 124 via a data communication link 126, which may, but need not be, a wired link. In the preferred embodiment described herein, wireless access point 120 includes a USB interface, peripheral device 124 includes a USB interface, and data communication link 126 represents a USB compatible link, e.g., a USB cable having connectors that are compatible with USB ports located on wireless access device 120 and peripheral device 124.

Briefly, computer network 100 allows USB compliant devices to be attached to a WLAN via wireless access device 120. Such USB compliant devices include, without limitation: video cameras, still cameras, motion sensors, video displays, hard drives or other memory devices (which can be useful for remote storage and event logging associated with wireless access device 120), printers, environmental control devices, wireless technologies such as short range or long range RF devices, RFID devices, or the like. Normal installations of a wireless access device utilize a wired connection to the computer network. Furthermore, wireless access devices are typically installed in unusual locations that are often void of existing LAN connections. Accordingly, the use of a USB compliant wireless access device provides an opportunity to connect peripheral devices to the WLAN and/or the LAN via wireless access device 120. Once coupled to computer network 100 in this manner, a peripheral device can be accessed by other network devices (which may reside on the WLAN or the LAN). In addition to the data interface aspect of this network architecture, the peripheral devices can be powered by wireless access device 120, which in turn might be powered by an external power supply (e.g., an AC outlet) or by using the power available over Ethernet networks in accordance with IEEE Standard 803.2af.

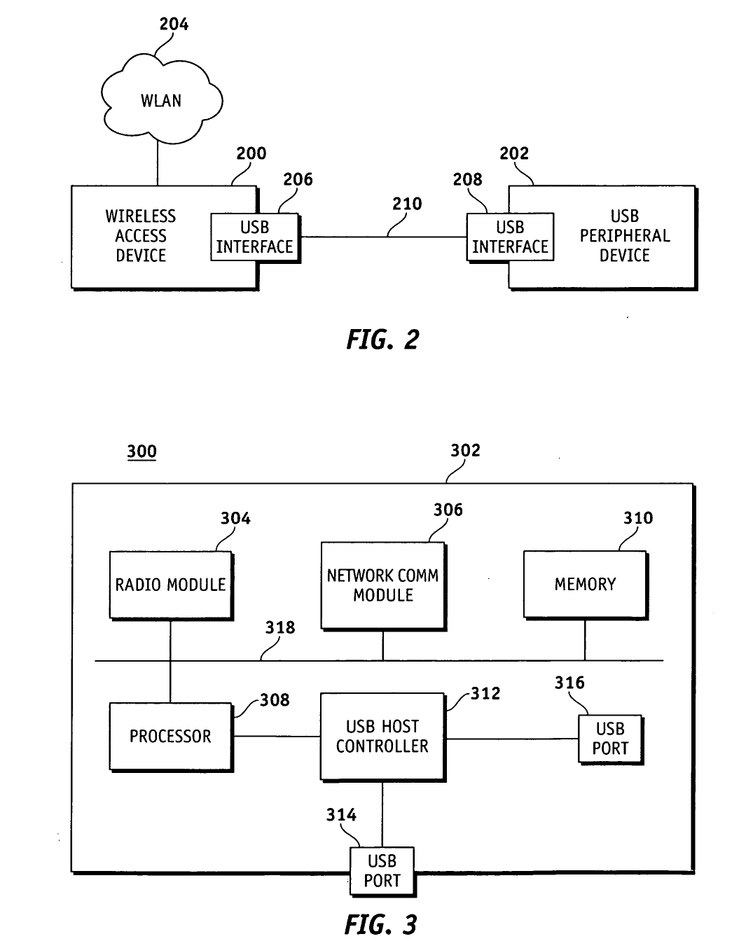

FIG. 2 is a schematic representation of a wireless access device 200 connected to a peripheral device 202 via USB interfaces. As used herein, a “USB interface” refers to the operating hardware, software, firmware, processing logic, and protocols, individually or in any combination thereof, that supports data communication in compliance with the USB standard. Accordingly, a USB interface may include physical and electrical elements, components, and/or features associated with the particular device. For example, a USB interface may include a USB port (a hardware element that provides physical and electrical connectivity) and a USB controller coupled to the USB port.

Wireless access device 200 may be considered to be a component of a WLAN 204. Wireless access device 200 includes an integrated USB interface 206 that is configured for interconnection with USB compliant peripheral devices such as peripheral device 202. Likewise, peripheral device 202 includes an integrated USB interface 208 that is configured for interconnection with wireless access device 200 via USB interface 206 (in this regard, peripheral device 202 is considered to be a USB compliant peripheral device). Thus, peripheral device 202 is coupled to wireless access device 200 via USB interfaces 206/208. In this example embodiment, USB interfaces 206/208 are coupled to each other via a USB cable 210 (or any suitable data communication technology that is USB compliant). The combination of wireless access device 200 and peripheral device 202 may be referred to herein as a wireless access subsystem for a WLAN.

FIG. 2 depicts one example arrangement where peripheral device 202 is a distinct component that is externally coupled to wireless access device 200 using an externally accessible USB port or connection point. In other words, at least a portion of USB interface 206 is externally accessible. In alternate embodiments, however, USB interface 206 may be contained within the housing or package for wireless access device 200 and peripheral device 202 may be realized as an internal subcomponent or an internally mounted device for wireless access device 200. Such internal installations of peripheral devices may be desirable to support feature enhancements, provide product upgrades, or to implement customized product specifications. For example, wireless access device 200 may include interior space that can accommodate small USB compliant memory storage devices. Such memory storage devices can provide additional capacity for event logging, error logging, trouble shooting data, firmware uploading, or the like.

In one practical embodiment of the invention, USB interface 206 comprises a master USB interface (also known as a host USB interface) and USB interface 208 comprises a slave USB interface (also known as a device USB interface). This arrangement can be utilized, for example, if peripheral device 202 is a memory storage device, a video camera, an environmental sensor, or other device that will be accessed by wireless access device 200 and/or by other network components via wireless access device 200. In an alternate embodiment, USB interface 206 comprises a slave USB interface and USB interface 208 comprises a master USB interface.

FIG. 3 is a schematic representation of a wireless access device 300 configured in accordance with an example embodiment of the invention. A practical embodiment of wireless access device 300 will include additional components and elements configured to support known or conventional operating features that need not be described in detail herein. In the example embodiment, wireless access device 300 is a wireless access point that transmits and receives data. An access point connects users to other users within the network and can also serve as the point of interconnection between a WLAN and a fixed wire network. Each access point can serve multiple users within a defined network area. As a wireless client moves beyond the range of one access point, the wireless client can be automatically handed over to another access device, e.g., a different access point or a wireless access port supported by a wireless switch. In practice, the number of wireless access devices in a given network generally increases with the number of network users and the physical size of the network.

Wireless access device 300 generally includes a physical housing 302, a radio module 304, a network communication module 306, a processor architecture 308, memory 310, and a USB interface that includes a USB host controller 312 and at least one USB port 314/316. These and other elements of wireless access device 300 may be interconnected together using a bus 318 or any suitable interconnection arrangement. Such interconnection facilitates communication between the various elements of wireless access device 300. In this example embodiment, all of the illustrated components other than USB port 314 are located within housing 302, which represents the physical package for wireless access device 300.

Radio module 304, which includes a receiver and a transmitter (or a transceiver), is configured to communicate with wireless clients via a wireless data communication link. Radio module 304 may cooperate with a suitably configured RF antenna arrangement (not shown) that supports the particular wireless communication protocol. In the example embodiment, radio module 304 is configured to support WLAN connectivity in compliance with established IEEE Standards, such as 802.1 a, 802.1 b, and 802.11a/b. Of course, radio module 304 may be configured to support alternate or additional wireless data communication protocols, including future variations of 802.11 such as 802.11a/b/g.

Network communication module 306 generally represents the hardware, software, firmware, processing logic, and/or other components of wireless access device 300 that enable bi-directional communication between wireless access device 300 and network components to which wireless access device 300 is connected. For example, network communication module may be configured to support 10/100 Mbps Ethernet LAN traffic. Referring to FIG. 1 as an example, network communication module 306 is suitably configured to transmit data to components on computer network 100 (such as wireless switch 112, Ethernet switch 114, and/or additional network components 122), and to receive data from components on computer network 100. In a typical deployment, network communication module 306 provides an Ethernet interface such that wireless access device 300 can communicate with a conventional Ethernet-based computer network. In this regard, network communication module 306 may include a physical interface, such as 10/100/1000 Mbps, for connection to the computer network, and network communication module 306 (and/or processor 308) may handle Ethernet addressing for data packets sent from wireless access device 300.

Processor architecture 308 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

As depicted in FIG. 3, processor architecture 308 is in communication with network communication module 306. In this example, processor architecture 308 is also in communication with radio module 304, memory 310, and the USB interface. Processor architecture 308 preferably includes processing logic that is configured to carry out the functions, techniques, and processing tasks associated with the operation of wireless access device 300.

Memory 310 may be implemented or realized with RAM memory, flash memory, ROM memory, EPROM memory, EEPROM memory, registers, a hard disk, a removable disk, a CD-ROM, or any other form of storage medium known in the art. In addition, memory 310 includes sufficient data storage capacity to support the operation of wireless access device 300. Memory 310 can be coupled to processor architecture 308 such that processor architecture 308 can read information from, and write information to, memory 310. In the alternative, memory 310 may be integral to processor architecture 308. As an example, processor architecture 308 and memory 310 may reside in a suitably configured ASIC.

The USB interface (which comprises USB host controller 312, USB port 314, and/or USB port 316) is suitably coupled to processor architecture 308 to facilitate data communication between USB compliant peripheral devices and network communication module 306. The USB interface may be coupled to a PCI bus in wireless access device 300, which can enable software downloads and potential firmware upgrades for the motherboard flash in wireless access device 300. Alternatively (or additionally), the USB interface may be coupled to an external memory bus in wireless access device 300. In one practical embodiment, the USB interface is located within housing 302 and is not externally accessible. USB port 316 depicts an internally located port that can be utilized for such an embodiment. In another practical embodiment, the USB interface is accessible from outside housing 302. USB port 314 depicts an externally accessible port that can be utilized for such an embodiment.

USB host controller 312 generally represents the hardware, software, firmware, processing logic, and/or other components of the USB interface that control data communication (which may be bi-directional) between wireless access device 300 and USB compliant peripheral devices that might be connected to USB ports 314/316. Thus, USB host controller 312 also functions to control and/or manage data communication between processor architecture 308 and USB compliant peripheral devices that might be connected to USB ports 314/316. In other words, the data exchanged with the USB compliant peripheral devices can be utilized by wireless access device 300 and/or by network components coupled to wireless access device 300 via network communication module 306, under the control of processor architecture 308.

As mentioned above, USB ports 314/316 are suitably configured to establish data communication with USB compliant peripheral devices. In practice, USB ports 314/316 have physical and electrical characteristics and features that are in compliance with the particular USB standard. In a practical deployment, USB ports 314/316 may be coupled to peripheral devices using USB cables. In alternate embodiments, the peripheral devices might be directly connected to USB ports 314/316.

While at least one example embodiment has been presented in the foregoing detailed description, it should be appreciated that a vast number of variations exist. For example, the inventive concepts described herein can be extended to IEEE 1394 interfaces and other external bus interfaces. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A wireless access device for a wireless local area network (“WLAN”), said wireless access device comprising an integrated universal serial bus (“USB”) interface configured for interconnection with USB compliant peripheral devices.

2. A wireless access device according to claim 1, said USB interface comprising a master USB interface.

3. A wireless access device according to claim 1, said USB interface comprising a slave USB interface.

4. A wireless access device according to claim 1, further comprising a housing, and said USB interface being accessible from outside said housing.

5. A wireless access device according to claim 1, further comprising a housing, and said USB interface being located within said housing.

6. A wireless access device according to claim 1, further comprising a network communication module configured to support data communication with a network component to which said wireless access device is connected, said USB interface being coupled to said network communication module.

7. A wireless access device according to claim 1, said wireless access device comprising a wireless access port.

8. A wireless access device according to claim 1, said wireless access device comprising a wireless access point.

9. A wireless access device according to claim 1, said USB interface comprising:
a USB port configured to establish data communication with USB compliant peripheral devices; and
a USB host controller coupled to said USB port, said USB host controller being configured to control data communication between said wireless access device and USB compliant peripheral devices.

10. A wireless access subsystem for a wireless local area network (“WLAN”), said wireless access subsystem comprising:
a wireless access device comprising an integrated universal serial bus (“USB”) interface; and
a USB compliant peripheral device coupled to said wireless access device via said USB interface.

11. A wireless access subsystem according to claim 10, said USB interface comprising a master USB interface, and said USB compliant peripheral device comprising a slave USB interface coupled to said master USB interface.

12. A wireless access subsystem according to claim 10, said USB interface comprising a slave USB interface, and said USB compliant peripheral device comprising a master USB interface coupled to said slave USB interface.

13. A wireless access subsystem according to claim 10, said wireless access device further comprising a housing, and said USB interface being accessible from outside said housing.

14. A wireless access subsystem according to claim 10, said wireless access device further comprising a housing, and said USB interface being located within said housing.

15. A wireless access subsystem according to claim 10, said wireless access device further comprising a network communication module configured to support data communication with a network component to which said wireless access device is connected, said USB interface being coupled to said network communication module.

16. A wireless access subsystem according to claim 10, said wireless access device comprising a wireless access port.

17. A wireless access subsystem according to claim 10, said wireless access device comprising a wireless access point.

18. A wireless access device for a wireless local area network (“WLAN”), said wireless access device comprising:
a radio module configured to communicate with client devices via wireless data communication links;
a network communication module coupled to said radio module, said network communication module being configured to support data communication with other network components; and
an integrated universal serial bus (“USB”) interface coupled to said network communication module, said USB interface being configured for interconnection with USB compliant peripheral devices.

19. A wireless access device according to claim 18, said USB interface comprising:
a USB port configured to establish data communication with USB compliant peripheral devices; and
a USB host controller coupled to said USB port, said USB host controller being configured to control data communication between said wireless access device and USB compliant peripheral devices.

20. A wireless access device according to claim 19, said USB host controller being configured to control data communication between said network communication module and USB compliant peripheral devices.
